(19) United States
(12) Patent Application Publication
(10) Pub. No.: US 2020/0116574 A1
(43) Pub. Date: Apr. 16, 2020

(54) TEMPERATURE MEASUREMENT APPARATUS, TEMPERATURE MEASUREMENT METHOD, AND NON-TRANSITORY COMPUTER-READABLE STORAGE MEDIUM FOR STORING TEMPERATURE MEASUREMENT PROGRAM

(71) Applicant: FUJITSU LIMITED, Kawasaki-shi (JP)

(72) Inventors: Takahiro Arioka, Isehara (JP); Kazushi Uno, Atsugi (JP); Takeo Kasajima, Machida (JP)

(73) Assignee: FUJITSU LIMITED, Kawasaki-shi (JP)

(21) Appl. No.: 16/713,059

(22) Filed: Dec. 13, 2019

Related U.S. Application Data
(63) Continuation of application No. PCT/JP2017/025372, filed on Jul. 12, 2017.

(51) Int. Cl. G01K 11/32

(52) U.S. Cl. CPC G01K 11/32; G01K 2011/324

(57) ABSTRACT

A temperature measurement apparatus includes: a plurality of optical fibers arranged along a predetermined path; a temperature measurement unit that measures a temperature distribution of the plurality of optical fibers in an extending direction on the basis of backscattered light from the optical fibers; and an averaging processing unit that averages, on the basis of a correlation among a plurality of temperature distributions measured by the temperature measurement unit in the predetermined path, the plurality of temperature distributions in a distance direction of the optical fibers.

### CROSS-REFERENCE TO RELATED APPLICATION

This application is a continuation application of International Application PCT/JP2017/025372 filed on Jul. 12, 2017 and designated the U.S., the entire contents of which are incorporated herein by reference.

### FIELD

The present invention relates to a temperature measurement apparatus, a temperature measurement method, and a non-transitory computer-readable storage medium for storing a temperature measurement program.

### BACKGROUND

There has been developed a technique of measuring a temperature distribution in the extending direction of an optical fiber using backscattered light from the optical fiber when light has entered the optical fiber from a light source.

Examples of the related art include Japanese Laid-open Patent Publication No. 07-218354 and Japanese Laid-open Patent Publication No. 2014-167399.

### SUMMARY

According to an aspect of the embodiments, a temperature measurement apparatus includes: a plurality of optical fibers arranged along a predetermined path; a temperature measurement unit that measures a temperature distribution of the plurality of optical fibers in an extending direction on the basis of backscattered light from the optical fibers; and an averaging processing unit that averages, on the basis of a correlation among a plurality of temperature distributions measured by the temperature measurement unit in the predetermined path, the plurality of temperature distributions in a distance direction of the optical fibers.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a schematic view of the general arrangement of a temperature measurement apparatus according to an embodiment; and FIG. 1B is a block diagram for describing a hardware configuration of a control unit.

FIG. 2 is a graph illustrating components of backscattered light.

FIG. 3A is a graph illustrating the relationship between elapsed time after light pulse emission by a laser and the respective light intensities of a Stokes component and an anti-Stokes component; and FIG. 3B illustrates temperature calculated using a detection result of FIG. 3A,

FIG. 4 is a graph illustrating a relationship between the light intensities of the Stokes component and the anti-Stokes component and the temperature.

FIG. 5 is a diagram and graphs for describing the rollover.

FIGS. 6A to 6C are a diagram and graphs illustrating an example of measuring the temperature in an LNG tank by an optical fiber.

FIGS. 7A and 7B are diagrams illustrating a protective tube.

FIG. 8 is a diagram and graphs illustrating averaging processing.

FIG. 9 is a diagram illustrating inverse filter processing.

FIGS. 10A to 10E are a diagram and graphs illustrating abnormality determination.

FIG. 11 is a diagram illustrating a flowchart.

FIG. 12 is a diagram illustrating a temperature measurement system.

### DESCRIPTION OF EMBODIMENT(S)

For example, a liquid density meter is generally used in LNG tank rollover monitoring. However, the liquid density meter needs to move up and down, has a large connection diameter with the tank, has low availability due to fixed fitting, and a problem of a difficulty in maintenance. Therefore, it is conceivable to monitor rollover by detecting the temperature of LNG using an optical fiber. However, there is a possibility that anti-Stokes light contained in backscattered light becomes small at a very low temperature and an S/N is deteriorated.

According to one aspect, an object of the present invention is to provide a temperature measurement apparatus, a temperature measurement method, and a temperature measurement program capable of measuring temperature with high accuracy.

The temperature can be measured with high accuracy.

Hereinafter, an embodiment will be described with reference to the drawings.

### Embodiment

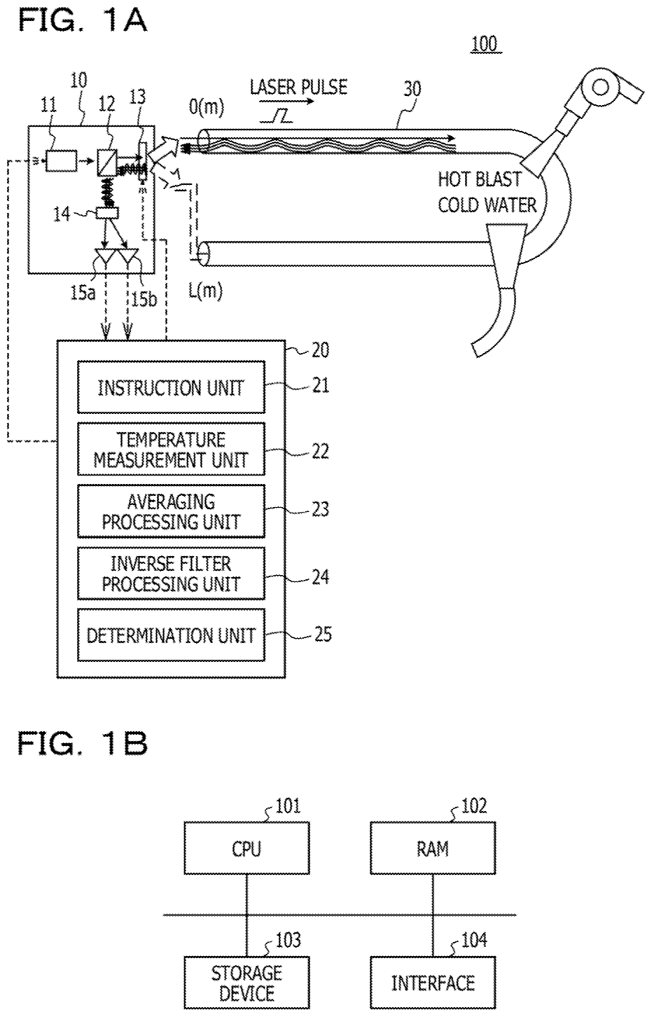

FIG. 1A is a schematic view of the general arrangement of a temperature measurement apparatus 100 according to an embodiment. As illustrated in FIG. 1A, the temperature measurement apparatus 100 includes, for example, a measurement device 10, a control unit 20, and an optical fiber 30. The measurement device 10 includes, for example, a laser 11, a beam splitter 12, an optical switch 13, a filter 14, a plurality of detectors 15a and 15b. The control unit 20 includes an instruction unit 21, a temperature measurement unit 22, an averaging processing unit 23, an inverse filter processing unit 24, a determination unit 25 and the like.

FIG. 1B is a block diagram for describing a hardware configuration of the control unit 20. As illustrated in FIG. 1B, the control unit 20 includes, for example, a CPU 101, a RAM 102, a storage device 103, and an interface 104. Each of these devices is connected via, for example, a bus. The central processing unit (CPU) 101 serves as a central processing unit. The CPU 101 includes one or more cores. The random access memory (RAM) 102 serves as a volatile memory that temporarily stores a program to be executed by the CPU 101, data to be processed by the CPU 101, and the like. The storage device 103 serves as a non-volatile storage device. Examples of the storage device 103 that can be used include a read only memory (ROM), a solid state drive (SSD) such as a flash memory, or a hard disk driven by a hard disk drive. The instruction unit 21, the temperature measurement unit 22, the averaging processing unit 23, the inverse filter processing unit 24, and the determination unit 25 are realized in the control unit 20 as the CPU 101 executes the temperature measurement program stored in the storage device 103. Note that the instruction unit 21, the temperature measurement unit 22, the averaging processing unit 23, the inverse filter processing unit 24, and the determination unit 25 may be hardware such as a dedicated circuit.

The laser 11 serves as a light source such as a semiconductor laser, and emits laser beams in a predetermined wavelength range in accordance with an instruction of the instruction unit 21. In the present embodiment, the laser 11 emits light pulses (laser pulses) at predetermined time intervals. The beam splitter 12 causes the light pulses emitted from the laser 11 to enter the optical switch 13. The optical switch 13 serves as a switch that switches an emission destination (channel) of the light pulses having entered. In a double-end scheme, the optical switch 13 causes the light pulses to alternately enter a first end and a second end of the optical fiber 30 at constant cycles according to an instruction of the instruction unit 21. In a single-end scheme, the optical switch 13 causes the light pulses to enter either the first end or the second end of the optical fiber 30 according to an instruction of the instruction unit 21. The optical fiber 30 is disposed along a predetermined path to be measured in temperature.

The light pulses having entered in the optical fiber 30 propagates in the optical fiber 30. The light pulses are gradually attenuated and propagate in the optical fiber 30 while generating forward scattered light traveling in the propagation direction of the light pulses and backscattered light (return light) traveling in the feedback direction of light pulses. The backscattered light passes through the optical switch 13 and re-enters the beam splitter 12. The backscattered light having entered the beam splitter 12 is emitted to the filter 14. The filter 14 serves as a WDM coupler or the like, and extracts the backscattered light into a long-wavelength component (Stokes component to be described below) and a short-wavelength component (anti-Stokes component to be described below). The detectors 15a and 15b serve as photoreceptors. The detector 15a converts the received light intensity of the short-wavelength component in the backscattered light into an electrical signal and transmits the electrical signal to the temperature measurement unit 22. The detector 15b converts the received light intensity of the long-wavelength component in the backscattered light into an electrical signal and transmits the electrical signal to the temperature measurement unit 22. The temperature measurement unit 22 measures the temperature distribution in the extending direction of the optical fiber 30, using the Stokes component and the anti-Stokes component. The averaging processing unit 23 performs averaging processing for the measured temperature distribution measured by the temperature measurement unit 22, thereby calculating a corrected measured temperature. The inverse filter processing unit 24 performs inverse filter processing for the corrected measured temperature calculated by the averaging processing unit 23. The determination unit 25 performs determination regarding abnormality on the basis of the corrected measured temperature after the inverse filter processing,

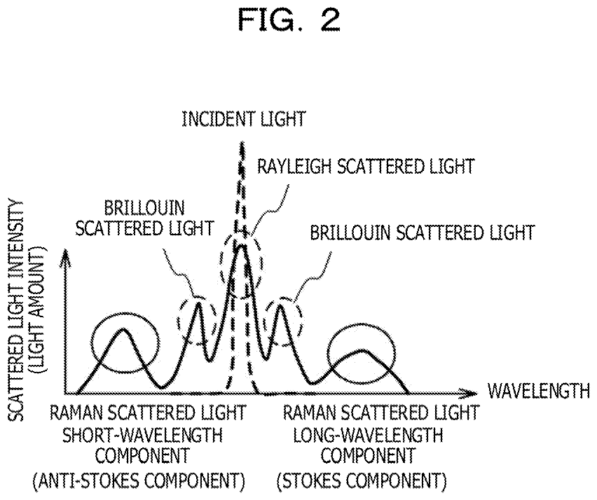

FIG. 2 is a graph illustrating components of the backscattered light. As illustrated in FIG. 2, the backscattered light is broadly classified into three types. These three types of light are, in descending order of light intensity and in order of wavelength close to the incident light wavelength: Rayleigh scattered light used for an optical pulse tester (OTDR) or the like; Brillouin scattered light used in strain measurement or the like; and Raman scattered light used in temperature measurement or the like. The Raman scattered light is generated due to the interference between lattice vibration that varies according to the temperature in the optical fiber 30 and light. The constructive interference generates the short-wavelength component called the anti-Stokes component, and the destructive interference generates the long-wavelength component called the Stokes component.

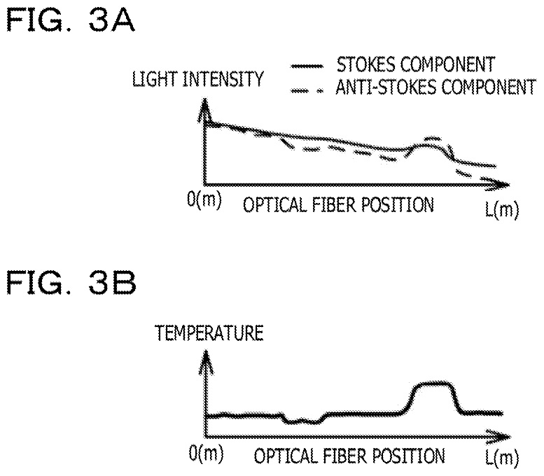

FIG. 3A is a graph illustrating the relationship between elapsed time after light pulse emission by the laser 11 and the respective light intensities of the Stokes component (long-wavelength component) and the anti-Stokes component (short-wavelength component), in a case where light has entered the first end of the optical fiber 30. The elapsed time corresponds to a propagation distance in the optical fiber 30 (a position in the optical fiber 30). As illustrated in FIG. 3A, the respective light intensities of the Stokes component and the anti-Stokes component both decrease with the elapsed time. This decrease results from the gradual attenuation and propagation of the light pulses in the optical fiber 30 while the light pulses generate the forward scattered light and the backscattered light.

As illustrated in FIG. 3A, the light intensity of the anti-Stokes component is higher at a position where the temperature is high in the optical fiber 30 than the light intensity of the Stokes component. On the other hand, the light intensity of the anti-Stokes component is lower at a position where the temperature is low in the optical fiber 30 than the light intensity of the Stokes component. Thus, detection of both components with the detectors 15a and 15b and use of the characteristic difference between both of the components enable detection of temperature at each position in the optical fiber 30. Note that in FIG. 3A, the region indicating the maximum is a region where the optical fiber 30 is intentionally heated with a dryer or the like in FIG. 1A. Furthermore, the region indicating the minimum is a region where the optical fiber 30 is intentionally cooled with cold water or the like in FIG. 1A.

In the present embodiment, the temperature measurement unit 22 measures the temperature from the Stokes component and the anti-Stokes component every elapsed time. As a result, the temperature at each sampling position in the optical fiber 30 can be measured. In other words, the temperature distribution in the extending direction of the optical fiber 30 can be measured. Note that due to the use of the characteristic difference between both components, even if the respective light intensities of both of the components are attenuated in accordance with the distance of the optical fiber 30, the temperature can be measured with high accuracy. FIG. 3B illustrates the temperature calculated using the detection result of FIG. 3A. The horizontal axis in FIG. 3B represents the position in the optical fiber 30 calculated on the basis of the elapsed time. As illustrated in FIG. 3B, the detection of the Stokes component and the anti-Stokes component enables the temperature measurement at each position in the optical fiber 30.

By the way, the Stokes component and the anti-Stokes component are transitions between levels of optical phonons. The Stokes component is a component generated by the transition from a ground state to an excited state. The anti-Stokes component is a component generated by the transition from the excited state to the ground state. In a state where the temperature is low, the intensity of the anti-Stokes component is low because there are few phonons in the excited state.

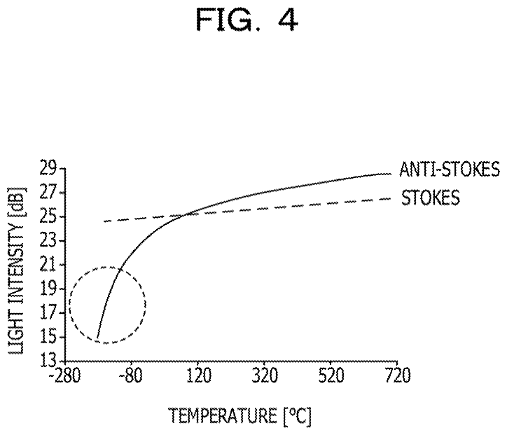

FIG. 4 is a graph illustrating a relationship between the light intensities of the Stokes component and the anti-Stokes component and the temperature. As illustrated in FIG. 4, the light intensity of the anti-Stokes component significantly decreases with respect to the light intensity of the Stokes component in a low-temperature range such as below a freezing point. Therefore, in the low-temperature range such as below the freezing point, a temperature error becomes large due to the definition of shot noise and the relationship between temperature and the Stokes component and the anti-Stokes with the significant decrease in the light intensity of the anti-Stokes component.

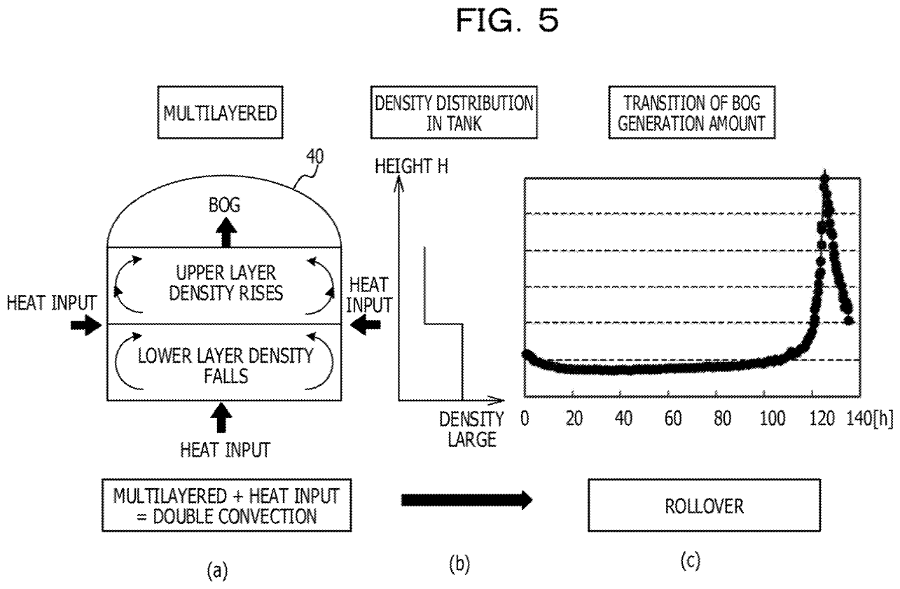

However, in facilities such as liquefied natural gas (LNG) tanks, a technique for measuring a very low temperatures is desired. Here, as an example, rollover in an LNG tank will be described. As illustrated in the section (a) of FIG. 5, LNG is stored in an LNG tank 40. The LNG tank 40 sometimes receives LNG from a plurality of ships. In this case, since LNG having different components is received, the LNG is multilayered in the LNG tank 40 due to a density difference based on a component difference of the LNG. In the example of the section (a) of FIG. 5, the LNG in the LNG tank 40 has two layers. As illustrated in the section (b) of FIG. 5, the lower layer is an LNG component with high density. The upper layer is an LNG component with low density.

In this state, when heat is input to the LNG tank 40, as illustrated in the section (a) of FIG. 5, convection (double convection) occurs in each layer. When the double convection occurs, each component and heat gradually move through a boundary between the upper layer and the lower layer. With the movement, the density of the upper layer and the density of the lower layer gradually approach each other. Furthermore, the density of the upper layer and the density of the lower layer gradually approach each other due to generation of boil-off gas (BOG) from the upper layer. When the difference between the density of the upper layer and the density of the lower layer becomes small, the upper layer and the lower layer are mixed and a rapid convection occurs (rollover). In the two-layered state, the generation of boil-off gas from the LNG component in the lower layer is suppressed by the presence of the LNG component in the upper layer. However, since the LNG component in the lower layer moves to the upper layer at the time of rollover, as illustrated in the section (c) of FIG. 5, a large amount of boil-off gas, which has been suppressed till then, is generated and a pressure in the tank is abnormally increased. Note that, in the section (c) of FIG. 5, the vertical axis represents the amount of the boil-off gas.

When the rollover occurs, a temperature change appears in the LNG tank 40 in advance. If this temperature change can be detected, the occurrence of rollover can be suppressed. However, the temperature difference between the upper and lower layers of the multi-layered LNG components is about several degrees Celsius. Furthermore, the temperature change with time is slight. Therefore, in the case of monitoring the rollover by optical fiber temperature measurement, measurement of temperatures of the respective layers of the multi-layered LNG components with high accuracy is required.

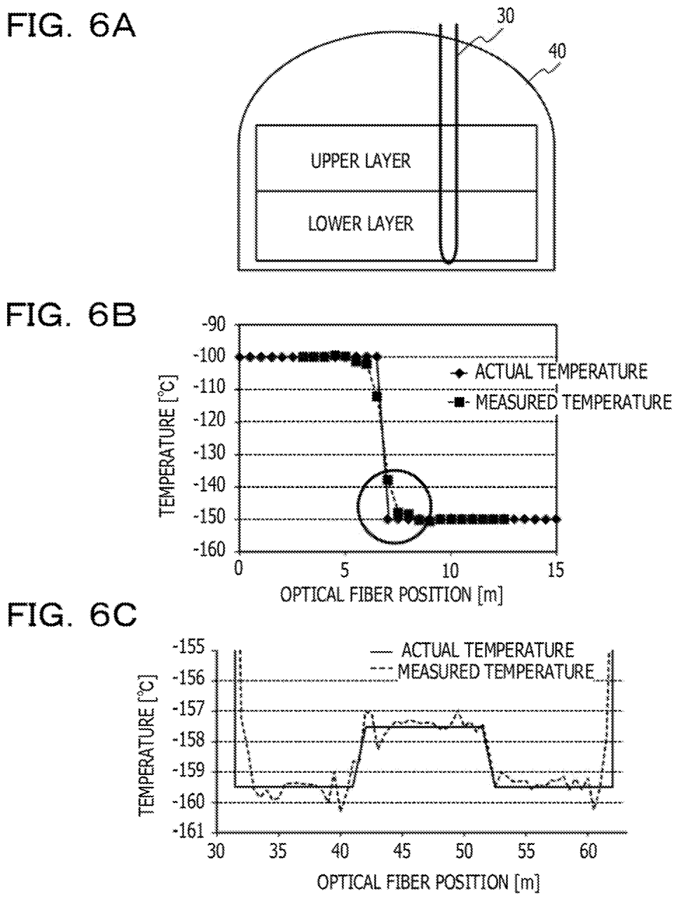

For example, as illustrated in FIG. 6A, the optical fiber 30 is extended downward from an upper part of the LNG tank 40, passes through the upper layer, is folded at a lower part of the lower layer (for example, the bottom of the LNG tank 40), and further passes through the upper layer and is extended to the upper part of the LNG tank 40. With the arrangement, a relatively low temperature is measured at a location where the optical fiber 30 is in contact with the upper layer, and a relatively high temperature is measured at a location where the optical fiber 30 is in contact with the lower layer.

In the optical fiber temperature measurement, an integrated value of light pulse width is acquired as the light intensity at an optical fiber position, Therefore, for a steep actual temperature distribution, a temperature distribution as if a low-pass filter is applied is obtained as measured temperatures, as illustrated in FIG. 6B, For this reason, the temperature accuracy becomes low at an interface between the LNG and the air where the temperature steeply changes in a longitudinal direction of the optical fiber, Therefore, it is conceivable to improve the temperature accuracy near the interface by applying an inverse filter that improves responsiveness. However, since the inverse filter is also applied to noise, high temperature accuracy is required when using the inverse filter.

Furthermore, since the LNG components are stored at a very low temperature, if the temperature is measured with an optical fiber, the measurement error becomes large, as described above. For example, as illustrated in FIG. 6C, there is a possibility that noise at a measured temperature becomes high. Therefore, the temperature measurement apparatus 100 according to the present embodiment has a configuration that improves the accuracy of temperature measurement,

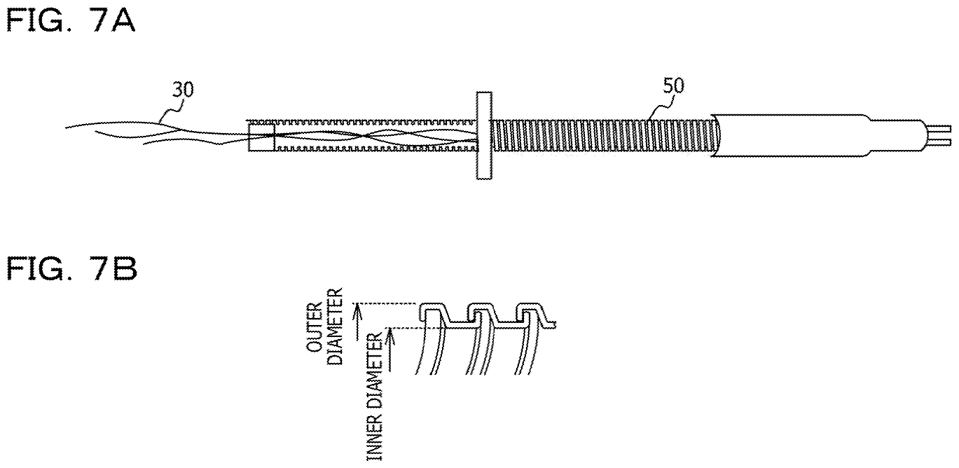

FIG. 7A is a view illustrating a protective tube 50 for protecting the optical fiber 30 brought into contact with the LNG components stored in the LNG tank 40. As illustrated in FIG. 7A, the protective tube 50 is, for example, a metal spiral tube. FIG. 78 is an enlarged view of a spiral portion of the protective tube 50. In the LNG tank 40, a flow is caused in the LNG due to mixing, inflow and discharge. Therefore, the protective tube 50 has air permeability and liquid permeability without shielding the optical fiber 30 from the LNG.

The protective tube 50 may have a length of several tens of meters, for example. Therefore, since the protective tube 50 can be wound up by being configured by a spiral tube, installation to and collection from the LNG tank 40 are easy. Therefore, replacement of the optical fiber 30 is easy. Furthermore, the protective tube 50 favorably has a weight such as an anchor so as not to flow by the flow of the LNG. Note that, as the optical fiber 30, use of a fiber coated with polyimide or the like that does not brittlely break even at a very low temperature is favorable.

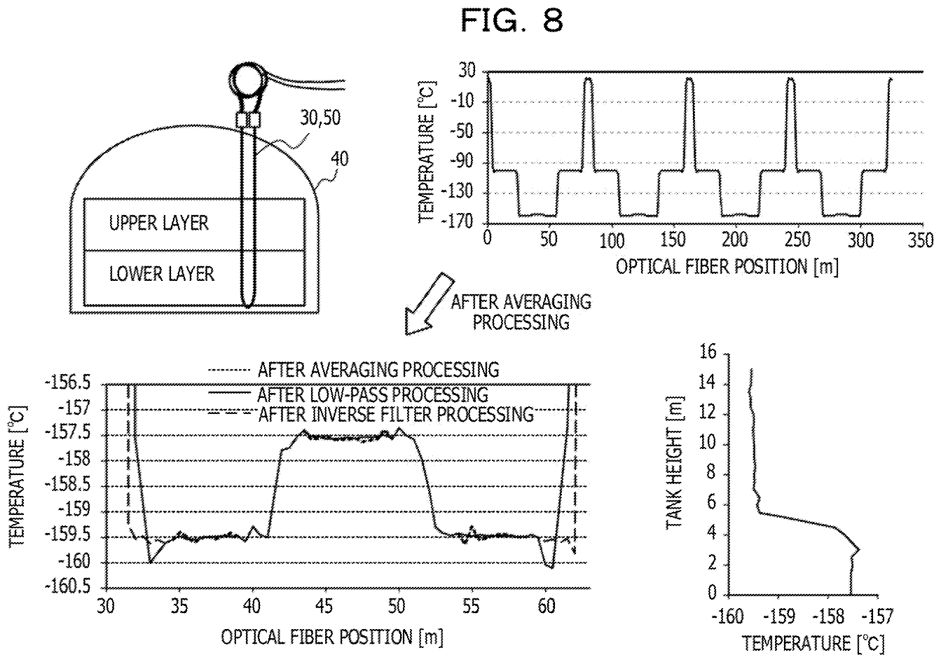

As illustrated in FIG. 8, the protective tube 50 is extended downward from an upper part of the LNG tank 40, passes through the upper layer, is folded at a lower part of the lower layer (for example, the bottom of the LNG tank 40), and further passes through the upper layer and is extended to the upper part of the LNG tank 40. The optical fiber 30 extends through the protective tube 50 from one end to the other end over a plurality of times. This means that a plurality of optical fibers is arranged in the protective tube 50.

With the arrangement, the measured temperatures of the optical fiber 30 at respective positions have the temperature distribution as illustrated in FIG. 8. In other words, the measured temperature is high (outside temperature) outside the LNG tank 40. In a gas part above the upper layer in the LNG tank 40, the measured temperature becomes drastically low and becomes a substantially constant temperature (for example, about −100° C.). This is because the temperature in the LNG tank 40 is kept substantially constant at a very low temperature. In the upper layer, the measured temperature becomes drastically low and becomes a substantially constant temperature (for example, about −160° C.). The measured temperature becomes slightly high at the boundary between the upper layer and the lower layer, and becomes a substantially constant temperature in the lower layer. The measured temperature becomes slightly low at the boundary between the lower layer and the upper layer, and becomes a substantially constant temperature in the upper layer. In the gas part, the measured temperature becomes drastically high and becomes a substantially constant temperature. The measured temperature becomes drastically high outside the LNG tank 40. Since the optical fiber 30 extends through the protective tube 50 over a plurality of times, this measured temperature cycle is repeated.

The measured temperature obtained by the optical fiber 30 provided along the same protective tube 50 should have the same temperature distribution. Therefore, a plurality of measured temperature distributions at a certain protective tube position should have a high correlation. Meanwhile, in a case of a low correlation, it is assumed that there is no temperature distribution and the correlation is low due to the influence of noise or the like.

A correlation coefficient R₁₂(x) of each of measured temperature distributions T₁ and T₂ in a sample range of ±L (m) centered on a certain protective tube position x (position in a height direction) can be obtained by, for example, the following expression (1). In the following expression (1), “T bar” (T with a bar attached to the top) is an average value in a sample range of ±L of the measured temperature T. “i” represents each position from −1 to +L.

$${R}_{12} ( x ) = \frac{{\sum }_{i = - L}^{L} ( {T}_{1} ( x + i ) - {\overline{T}}_{1} ) ( {T}_{2} ( x + i ) - {\overline{T}}_{2} )}{{( ( {\sum }_{i = - L}^{L} {( {T}_{1} ( x + i ) - {\overline{T}}_{1} )}^{2} ) ( {\sum }_{i = - n / 2}^{n / 2} {( {T}_{2} ( x + i ) - {\overline{T}}_{2} )}^{2} ) )}^{1 / 2}}$$

If a noise component for a temperature signal is small in both the measured temperature distribution T₁ and the measured temperature distribution T₂, the measured temperature distribution T₁ and the measured temperature distribution T₂ are similar. In this case, the correlation coefficient R₁₂(x) becomes a large value. Therefore, if the correlation coefficient is large, the accuracy of the measured temperature at the position x is high. Therefore, the averaging processing unit 23 outputs an average value of the measured temperatures at the position x as the temperature at the position x if the correlation coefficient exceeds a certain threshold value. In this case, the averaging processing unit 23 can output the measured temperature obtained with high accuracy.

Meanwhile, if the noise component for the temperature signal is large in at least either the measured temperature distribution T₁ or the measured temperature distribution T₂, the similarity between the measured temperature distribution T₁ and the measured temperature distribution T₂ decreases. In this case, the correlation coefficient R₁₂(x) becomes a small value. Therefore, if the correlation coefficient is small, the accuracy of the measured temperature at the position x is low. Therefore, in a case where the correlation coefficient is equal to or smaller than the threshold value, the averaging processing unit 23 outputs an average value of average temperatures in the range of ±L centered on the position x as the temperature at the position x in each of the measured temperature distributions T₁ and T₂. In this case, since the measured temperatures are averaged within the range of ±L, the influence of noise can be suppressed. For example, a wider range to be used for averaging may be adopted in the measured temperature distribution as the correlation coefficient becomes smaller. L is favorably set to about the width of the light pulse because the effect of averaging is small if L is too short and a high frequency component of the temperature distribution is lost if L is too long.

Alternatively, the degree of averaging may be determined on the basis of the correlation coefficient. For example, the averaging range may be determined by a sum ER of correlation coefficients created from a plurality of measured temperature distributions. When ΣR<0, an average temperature in the range of ±L centered on the position x is output, and when ΣR>0, an average temperature in a range of ±{L−f(ΣR)} is output.

The averaging processing unit 23 outputs a corrected temperature distribution corrected by the averaging processing for each position in the height direction of the protective tube 50. Thereby, the temperature distribution of the protective tube 50 in the height direction is output. The dotted line in FIG. 8 illustrates the corrected temperature distribution after the averaging processing.

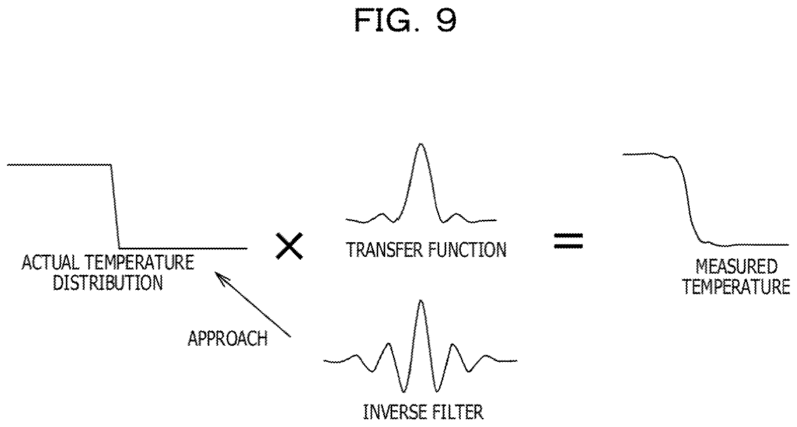

The inverse filter processing unit 24 applies inverse filter processing for improving the responsiveness to the corrected temperature distribution output by the averaging processing unit 23. A measured temperature T can be expressed by the following expression (2) in a matrix expression, assuming that the optical fiber temperature measurement is a linear system. In the following expression (2), T′ represents an actual temperature distribution, and [H] represents a transfer function. The transfer function is obtained from impulse response in the optical fiber temperature measurement. Since the inverse filter of the transfer function can be expressed as [H]⁻¹, the following expression (3) is obtained. The inverse filter processing unit 24 applies the inverse filter processing to the measured temperature distribution output by the averaging processing unit 23 to calculate the corrected temperature distribution, as illustrated in FIG. 9. The broken line in FIG. 8 and the solid line in FIG. 8 illustrate the corrected temperature distribution after the inverse filter processing. Thereby, a temperature distribution close to the actual temperature distribution can be obtained, Note that the inverse filter processing unit 24 may perform low-pass filter processing before applying the inverse filter processing. The solid line in FIG. 8 illustrates the measured temperature after the low-pass filter processing.

T′=[H]⁻¹T

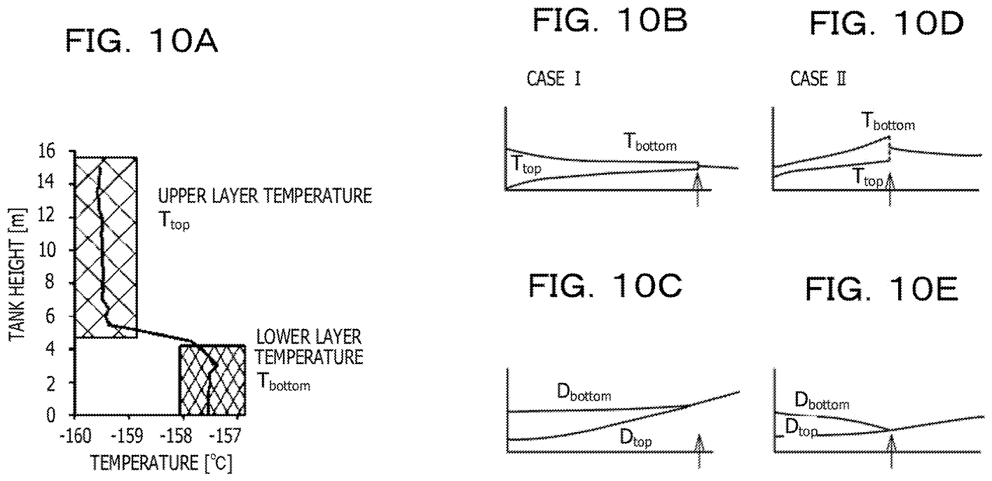

Next, the determination unit 25 determines whether an abnormality has occurred in the LNG tank 40 on the basis of the corrected temperature distribution. FIG. 10A is a diagram illustrating an upper layer temperature Tₜₒₚ and a lower layer temperature T_{bottom}. As illustrated in FIG. 10A, the upper layer temperature Tₜₒₚ is a temperature lower than the lower layer temperature T_{bottom}. Therefore, there is a predetermined difference between the upper layer temperature Tₜₒₚ and the lower layer temperature T_{bottom}, When this difference becomes small, a difference between density Dₜₒₚ of the upper layer and density D_{bottom} of the lower layer becomes small, and rollover occurs. Therefore, the occurrence of rollover can be detected in advance by detecting the difference between the upper layer temperature Tₜₒₚ and the lower layer temperature T_{bottom}.

FIG. 10B is a diagram illustrating the upper layer temperature Tₜₒₚ and the lower layer temperature T_{bottom} in a case where an inflow of external heat is smaller than cooling by evaporation (case 1). FIG. 10C is a diagram illustrating the density Dₜₒₚ of the upper layer and the density D_{bottom} of the lower layer in case 1. In case 1, the difference between the upper layer temperature Tₜₒₚ and the lower layer temperature T_{bottom} becomes gradually small with time. Therefore, output of a warning regarding rollover is favorable in a case of T_{bottom}−Tₜₒₚ<Threshold value Tₜₕ₁.

FIG. 10D is a diagram illustrating the upper layer temperature Tₜₒₚ and the lower layer temperature T_{bottom} in a case where an inflow of external heat is larger than cooling by evaporation (case 2). FIG. 10E is a diagram illustrating the density Dₜₒₚ of the upper layer and the density D_{bottom} of the lower layer in case 1. In case 2, the difference between the upper layer temperature Tₜₒₚ and the lower layer temperature T_{bottom} becomes gradually large with time, and the difference drastically disappears. Furthermore, the lower layer temperature T_{bottom} becomes gradually large with time. Therefore, output of a warning regarding rollover is favorable in a case of T_{bottom}−Tₜₒₚ>Threshold value Tₜₕ₂ and T_{bottom}>Threshold value T.

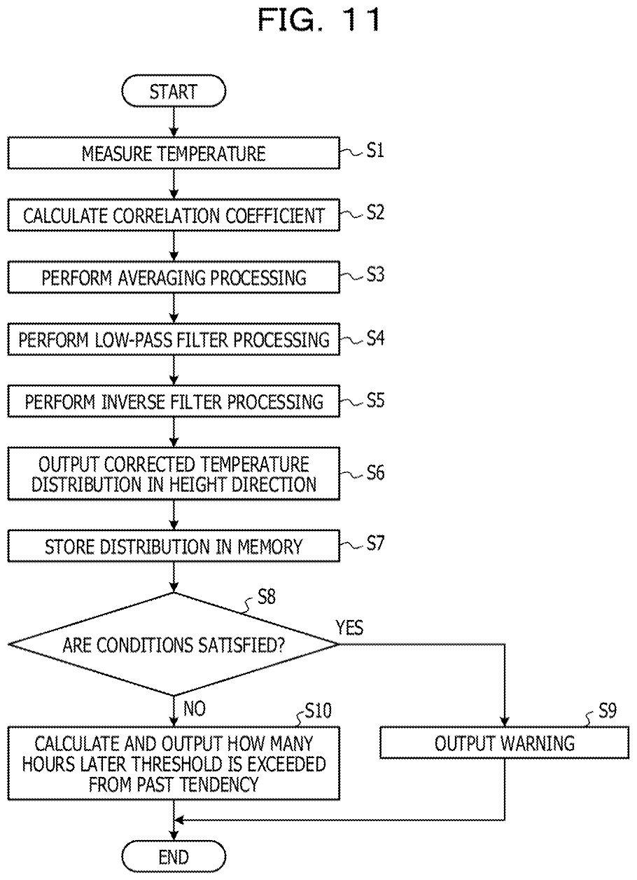

FIG. 11 is a diagram illustrating a flowchart representing the above processing. Hereinafter, a flow of the processing of each unit will be described with reference to the flowchart in FIG. 11. First, the temperature measurement unit 22 periodically measures the temperature of the optical fiber 30 at each sampling position in predetermined cycles (step S1). Next, the averaging processing unit 23 calculates the correlation coefficient of the measured temperature distribution at each position x in a depth direction of the LNG tank 40 (step S2). The correlation coefficient is calculated by, for example, the above expression (1). Next, the averaging processing unit 23 performs the averaging processing on the basis of the correlation coefficient calculated in step S2 (step S3).

Next, the inverse filter processing unit 24 performs the low-pass filter processing for the corrected temperature distribution obtained in step S3 (step S4). Thereby, the influence of noise can be suppressed. Next, the inverse filter processing unit 24 performs the inverse filter processing for the corrected temperature distribution obtained in step S4 (step S5). Next, the inverse filter processing unit 24 outputs the temperature distribution obtained by the inverse filter processing as the temperature distribution in the height direction of the LNG tank 40 (step S6).

The temperature distribution output in step S6 is stored in the RAM 102, the storage device 103, or the like (step S7). Next, the determination unit 25 determines whether or not the relationship between the upper layer temperature and the lower layer temperature satisfies the predetermined conditions described with reference to FIGS. 10A to 10E (step S8). In the case where “Yes” is determined in step S8, the determination unit 25 outputs the warning regarding rollover (step S9). In the case where “No” is determined in step S8, the determination unit 25 determines whether or not the conditions in step S8 are satisfied how many hours later from a past tendency, and outputs a result (step S10). After execution of step S9 and step S10, the flowchart ends.

According to the present embodiment, a plurality of temperature distributions measured using the backscattered light from a plurality of optical fibers arranged in the protective tube 50 is averaged on the basis of the correlation of the plurality of temperature distributions. Thereby, temperature measurement can be performed with high accuracy.

Note that, in the present embodiment, the plurality of optical fibers is provided in the protective tube 50 by extending one optical fiber 30 in the protective tube 50 over a plurality of times. However, an embodiment is not limited to the case. For example, a plurality of separated optical fibers may be arranged in the protective tube 50, and the temperature at each position in the protective tube 50 may be measured using each optical fiber.

### Another Example

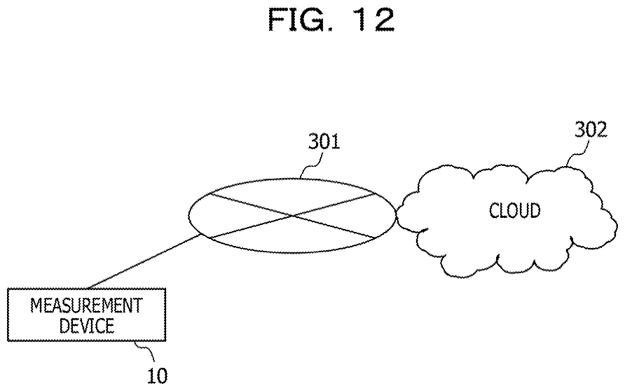

FIG. 12 is a diagram illustrating a temperature measurement system. As illustrated in FIG. 12, the temperature measurement system has a configuration in which a measurement device 10 is connected to a cloud 302 through a telecommunication line 301 such as the Internet. The cloud 302 includes, for example, a CPU 101, a RAM 102, a storage device 103, an interface 104, such as in FIG. 1B, and provides a function as a control unit 20. For such a temperature measurement system, for example, measurement results measured in a foreign LNG tank are received by the cloud 302 installed in Japan, and a temperature distribution is measured. Note that instead of the cloud 302, a server connected via an intranet or the like may be used.

In each of the above examples, the optical fiber 30 is an example of a plurality of optical fibers arranged along a predetermined path. The temperature measurement unit 22 is an example of a temperature measurement unit that measures a temperature distribution of the plurality of optical fibers in an extending direction on the basis of backscattered light from the optical fibers. The averaging processing unit 23 is an example of an averaging processing unit that averages, on the basis of a correlation among a plurality of temperature distributions measured by the temperature measurement unit in the predetermined path, the plurality of temperature distributions in a distance direction of the optical fibers. The inverse filter processing unit 24 is an example of an inverse filter processing unit that applies an inverse filter of a transfer function of temperature measurement by the temperature measurement unit to a corrected temperature distribution corrected by the averaging by the averaging processing unit. The determination unit 25 is an example of a determination unit that acquires each of the corrected measured temperatures for the upper layer and the lower layer, respectively, and performs determination regarding abnormality of the liquefied natural gas according to a difference between the acquired corrected measured temperatures.

Although the embodiments of the present invention have been described above in detail, the present invention is not limited to such specific embodiments, and various modifications and alterations may be made within the scope of the gist of the present invention described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A temperature measurement apparatus comprising:
a plurality of optical fibers arranged along a predetermined path;
a temperature measurement unit that measures a temperature distribution of the plurality of optical fibers in an extending direction on the basis of backscattered light from the optical fibers; and
an averaging processing unit that averages, on the basis of a correlation among a plurality of temperature distributions measured by the temperature measurement unit in the predetermined path, the plurality of temperature distributions in a distance direction of the optical fibers.

2. The temperature measurement apparatus according to claim 1, wherein the averaging processing unit determines a range or a degree of averaging the plurality of temperature distributions in a distance direction of the optical fibers on the basis of the correlation among the plurality of temperature distributions, and averages the plurality of temperature distributions on the basis of the determined range or degree.

3. The temperature measurement apparatus according to claim 1, further comprising:
an inverse filter processing unit that applies an inverse filter of a transfer function of temperature measurement by the temperature measurement unit to a corrected temperature distribution corrected by the averaging by the averaging processing unit.

4. The temperature measurement apparatus according to claim 1, further comprising:
a metal spiral tube provided along the predetermined path, wherein
the plurality of optical fibers is arranged to extend in the metal spiral tube in a distance direction.

5. The temperature measurement apparatus according to claim 1, wherein the predetermined path is provided to pass through a liquefied natural gas.

6. The temperature measurement apparatus according to claim 5, wherein
the liquefied natural gas forms an upper layer and a lower layer according to a difference in density, and
the predetermined path is provided to straddle the upper layer and the lower layer.

7. The temperature measurement apparatus according to claim 6, further comprising:
a determination unit that acquires the corrected measured temperatures for the upper layer and the lower layer, respectively, and performs determination regarding abnormality of the liquefied natural gas according to a difference between each of the acquired corrected measured temperatures.

8. The temperature measurement apparatus according to claim 7, wherein the determination unit outputs information regarding abnormality when a value obtained by subtracting the corrected measured temperature of the upper layer from the corrected measured temperature of the lower layer is less than a first threshold value, or the value obtained by subtracting the corrected measured temperature of the upper layer from the corrected measured temperature of the lower layer exceeds a second threshold value and the corrected measured temperature of the lower layer exceeds a third threshold value.

9. The temperature measurement apparatus according to claim 1, wherein the optical fibers are coated with polyimide.

10. A temperature measurement method comprising:
measuring, by a temperature measurement unit, a temperature distribution of a plurality of optical fibers in an extending direction on the basis of backscattered light from the plurality of optical fibers arranged along a predetermined path; and
averaging, by an averaging processing unit, on the basis of a correlation among a plurality of temperature distributions measured by the temperature measurement unit in the predetermined path, the plurality of temperature distributions in a distance direction of the optical fibers.

11. A non-transitory computer-readable storage medium for storing a temperature measurement program which causes a processor to perform processing, the processing comprising:
measuring a temperature distribution of a plurality of optical fibers in an extending direction on the basis of backscattered light from the plurality of optical fibers arranged along a predetermined path; and
averaging, on the basis of a correlation among a plurality of temperature distributions measured by the processing of measuring the temperature distribution in the predetermined path, the plurality of temperature distributions in a distance direction of the optical fibers.
